(19) United States
(12) Patent Application Publication
(10) Pub. No.: US 2012/0284096 A1
(43) Pub. Date: Nov. 8, 2012

(54) Resource Usage Reduction via Incentives

(76) Inventors: Naini Rose Gomes, Palo Alto, CA (US); Min-Wook Jeong, Stanford, CA (US); Deepak Merugu, Stanford, CA (US); Shivakumar Narayanan, Los Altos, CA (US); Balaji S. Prabhakar, Palo Alto, CA (US); Damon J. Wischik, Palo Alto, CA (US)

(21) Appl. No.: 13/464,860

(22) Filed: May 4, 2012

Related U.S. Application Data
(60) Provisional application No. 61/518,417, filed on May 4, 2011.

(51) Int. Cl. G06Q 30/02

(52) U.S. Cl. 705/14.14

(57) ABSTRACT

Conservation of a utility resource is incentivized by a method in which a utility customer records utility meter readings with a smart phone and submits the readings to a server for processing. The server processes the meter readings and awards the customer with credit awards contingent upon customer compliance with behavior that is being incentivized by the system, e.g., reduced resource use during peak hours, resource use below a target level set by the server, resource use below a goal set by the customer, frequent and accurate resource meter submissions, or verification of resource submissions of other customers. Cumulative awarded credits may be redeemed by a customer in exchange for participation in a micro-raffle or other game of chance. Preferably, a consumer awarded more credits has a greater chance of winning a prize, and a greater chance of winning a larger prize, than a user awarded fewer credits.

### CROSS-REFERENCE TO RELATED APPLICATIONS

This application claims priority from U.S. Provisional Patent Application 61/518,417 filed May 4, 2011, which is incorporated herein by reference.

### FIELD OF THE INVENTION

The present invention relates generally to methods for measuring utility meters and incentivizing efficient use of utility resources such as gas, water, and electricity.

### BACKGROUND OF THE INVENTION

As resources such as gas, water, and electricity become more scarce, the importance of conservation and efficient use of such resources becomes increasingly important. There are several challenges in increasing conservation and efficiency in the case of resource use via a public utility. One challenge relates to the lack of accurate and up-to-date resource use information. While smart meters can provide real-time feedback, they are expensive to deploy and maintain. Another challenge with resource conservation is related to behavior modification. Energy efficient technologies, for example, only help reduce consumption to a limited degree as long as consumers do not control the heating, cooling, and lighting in their homes with energy conservation in mind. Effectively changing consumer behavior, however, remains a challenge. Thus, there remains a long-standing need to provide accurate, up-to-date, and inexpensive methods for measuring utility meters and for incentivizing conservation of resources used by utility customers.

### SUMMARY OF THE INVENTION

In one aspect, the invention provides a method for incentivizing efficient use of a utility resource such as gas, water, or electricity. A user device, such as a smart meter or portable smart phone, records a current utility meter reading such as a numerical value representing utility use and/or image of the meter. The meter reading may be recorded by manual entry by a user, automatically by a wired or wireless connection to the meter, or by processing a digital image of the meter. In some embodiments, the smart phone may display a utility meter avatar while the user is taking a meter reading photograph or entering a meter reading manually. The utility meter reading is preferably tagged with associated metadata including timestamp, location, and meter serial number.

The recorded current utility meter reading and associated information is then sent from the user device to a server where it is processed. The processing may include identifying the user account by identifying information such as meter serial number, account number, and/or location information. The server may also process an image of the current utility meter reading to recognize a digital value representing a meter reading. The recognized digital value may then be compared with a digital value submitted by the user as a verification. The location and time metadata of the image may also be used to validate the authenticity of the image by comparing it with time and location metadata stored at the server and associated with the user account.

The server also processes the current meter reading data to assign to the user a credit award if the recorded current utility meter reading indicates that the user engaged in desirable resource consumption. Such desirable resource consumption may be computed, for example, based on a predetermined function computed on the set of utility meter readings and the times that those readings were submitted, e.g., awarding credits if the maximum time interval between readings over the course of a week is less than a predetermined minimum value. If this condition is met, then the server awards credits to the user. Alternatively, or in addition, the determination of whether the user engaged in desirable resource consumption may be based on many other conditions. For example, credits may be awarded if the user reduced consumption during peak hours, if utility meter readings are submitted by the user above a predetermined frequency, if utility meter readings submitted by the user are verified as being accurate, or if the user verifies a utility meter reading submitted by another user. Thus, in some embodiments, the method may include transmitting by the server to the user device a randomly selected utility meter reading submitted by another user, where the utility meter reading includes an image of a utility meter and a numerical value, displaying by the user device the image of the utility meter and the numerical value, receiving by the server from the user device a verification of the numerical value, and awarding by the server to the user a credit award.

In some embodiments, the method may include calculating by the server a target resource use profile for the user based on past resource use by the user and weather forecasts, and awarding by the server to the user a credit award if the recorded current utility meter reading indicates that the user resource consumption is less than the target resource use profile. In some embodiments, the method may include calculating by the server a utility use recommendation for the user based on past use by the user, and awarding by the server to the user a credit award if the recorded current utility meter reading indicates that the user followed the utility use recommendation. In some embodiments, the method may include calculating by the server a utility use recommendation for the user based on projected utility demands, and awarding by the server to the user a credit award if the recorded current utility meter reading indicates that the user followed the utility use recommendation. In some embodiments, the method may include receiving by the server from the user a utility use goal for a specified time period, and awarding by the server to the user a credit award if the recorded current utility meter reading indicates that the user met the utility use goal. Users may also be awarded by the server a credit award if the user submits to the server a photo of a utility bill of the user. Such a bill may be used by the server for meter reading verification, or for initially registering by the server a new user account for the user.

In some embodiments, the method may also include sending to the user device information including cumulative awarded credits earned and historical user data, both of which may be displayed on the user device. Embodiments also preferably allow the user to also view the same information on a desktop computer using a browser application program. Historical user data may be displayed, for example, as a graph of past meter reading values with respect to time, superimposed on a target resource use profile which may include a resource use zone associated with increased award credits. The graph may be displayed such that it represents the historical user data as the progress of an animal.

In some embodiments, the method includes transmitting by the server to a social network credit award information associated with the user device, whereby the credit award information may be shared in the social network with neighbors of the user. The method may also include transmitting from the server to the user device credit award and/or resource use information of other users, and displaying the credit award and/or resource use information of other users on the user device in comparison to the credit award and/or resource use information of the user.

The method also allows the user to redeem accumulated credit awards for user participation in a micro-raffle or other game of chance (i.e., any scheme wherein participation by a user results in a less than 100% chance of receiving a reward). For example, the server may provide and transmit information to the user device for displaying a random rewards interface on the user device. The random rewards interface may implement a lottery, micro-raffle, or other game of chance. For example, the server may randomly select one or more winners from among users awarded credits, and transfer rewards to the randomly selected winners. In some embodiments, the random selection by the server is performed such that a user awarded more credits has a greater chance of being selected than a user awarded fewer credits. In addition, the random selection by the server is preferably performed such that a user awarded more credits has a greater chance of being selected for a larger reward than a user awarded fewer credits.

### BRIEF DESCRIPTION OF THE DRAWINGS

FIG. 1 is a block diagram of a system in which a method may be implemented for incentivizing efficient use of a utility resource, according to an embodiment of the invention.

FIG. 2 is a flowchart outlining a method for incentivizing efficient use of a utility resource, according to an embodiment of the invention.

FIG. 3 is a diagram of a smart phone user interface used for capturing and recording a current reading of a resource utility meter, according to an embodiment of the invention.

FIG. 4 is a diagram of a smart phone user interface used for displaying historical user resource use data, target profile, and associated reward credits, according to an embodiment of the invention.

FIG. 5 is a diagram of a smart phone user interface used for displaying credits awarded to other users in the user's community for comparison with credits awarded to the device user, according to an embodiment of the invention.

FIG. 6 is a diagram of a smart phone user interface used for displaying a random reward interface by which the user may redeem credits in exchange for participation in a game of chance, according to an embodiment of the invention.

FIG. 7 is a diagram illustrating a multi-level pyramid reward structure of a credit redemption scheme, according to an embodiment of the invention.

### DETAILED DESCRIPTION

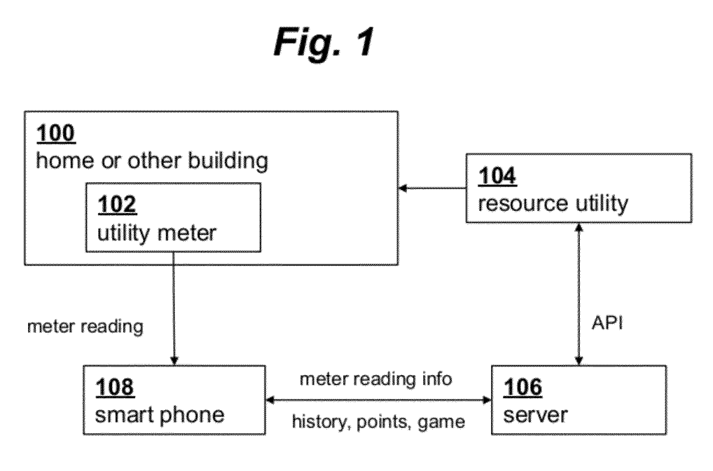

Embodiments of the present invention may be implemented in a system as shown schematically in FIG. 1. A home or other building 100 containing resource-consuming appliances receives resources from a utility 104 that distributes resource, e.g., through an electrical power grid, natural gas pipelines, or other means. Utility 104 also is used by many other utility customers, but only home 100 is shown for simplicity. The utility 104 would normally obtain resource use information about user 100 from manual readings of a conventional meter 102 or from a smart meter which provides real time resource use information. In a preferred embodiment of the present system, however, a smart phone 108 typically operated by the resident of home 100 is used to read the meter 102, and it sends the meter reading and other information from the device to the server 106. In turn, server 106 sends information back to smart phone 108, implementing bi-directional client-server communications to enable features as will be described in more detail below. In addition, Server 106 communicates via an application program interface (API) with the resource utility 104.

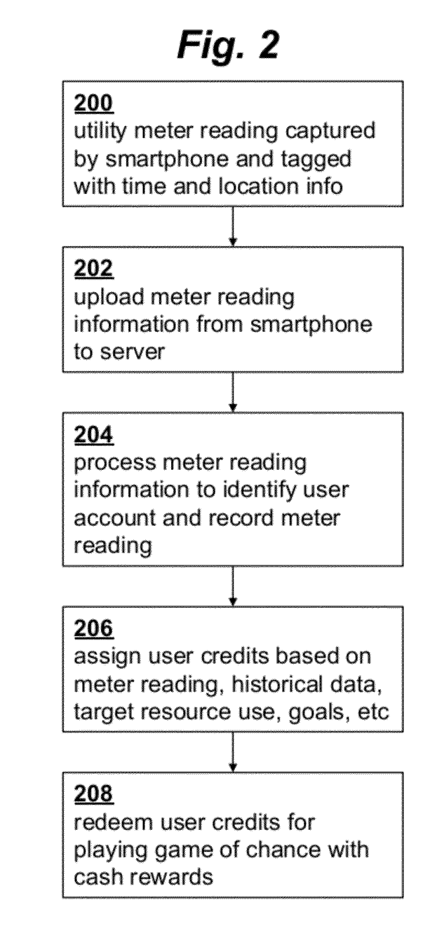

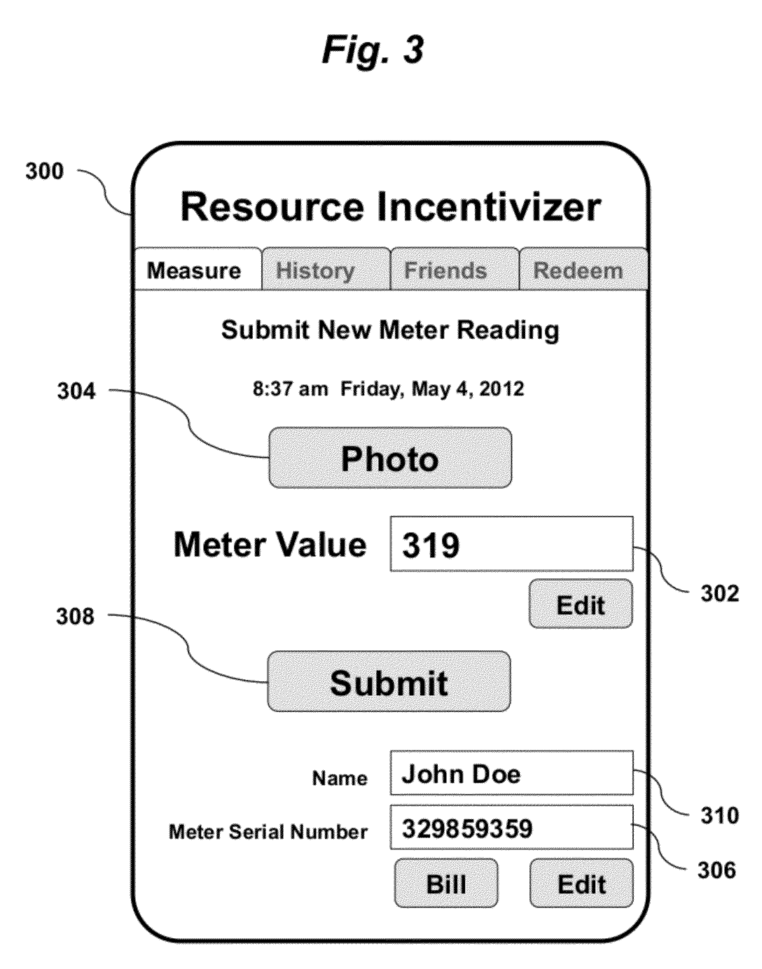

A method for incentivizing efficient use of a utility resource, according to an embodiment of the invention is shown in the flowchart of FIG. 2. In step 200 a user device, such as a smart meter or portable smart phone, records a current utility meter reading such as a numerical value representing utility use and/or image of the meter. The meter reading may be recorded by manual entry by a user, automatically by a wired or wireless connection to the meter, or by processing a digital image of the meter. For example, in one embodiment shown in FIG. 3, a smart phone user interface 300 is provided for capturing and recording a current reading of a resource utility meter. The phone executes an application program that allows the user to manually enter the current numerical value of the user's resource meter in field 302. Alternatively, or in addition, the user can select a photo button 304 that integrates with the smartphone digital camera, allowing the user to take a photo of the meter. GPS location and timestamp metadata are preferably added to the photo. The photo and/or meter reading value 302 are recorded in a memory of the device together with a meter serial number 306 and possibly other information associated with the user's account. The user then may select the submit button 308 which instructs the phone to transmit the meter reading value, photo, serial number, and/or other user data via a wireless data connection to the server. In alternate embodiments, the smart phone user interface may display a utility meter avatar (e.g., a user-selected animal) while the user is taking a meter reading photograph or entering a meter reading manually.

Returning now to FIG. 2, the uploading process is represented by step 202. After the meter reading value and associated data are uploaded to the server, in step 204 the server processes the information. The processing may include identifying the user account by identifying information such as meter serial number, account number, and/or location information. The server may also process an image of the current utility meter reading, using optical character recognition or other image recognition techniques to recognize in the image a digital value representing a meter reading. The recognized digital value may then be compared by the server with a digital meter reading value submitted by the user as a verification of the digital meter reading value. The location and time metadata of the image may also be used to validate the authenticity of the image by comparing it with time and location metadata stored at the server and associated with the user account. The server may also perform various other processes, and return information to the user, as will be described in more detail later on below.

In step 206 the server processes the current meter reading data to assign to the user a credit award. The server may award credits to the user subject to various predetermined criteria indicating that the user engaged in desirable resource consumption behavior. Such criteria may be used separately in different embodiments, but typically a set of such criteria are combined and used together so that credit awards may be earned in any of various different ways. For example, if the recorded current utility meter reading indicates that the user reduced resource consumption during peak hours, the server can assign an award credit to the user. Awards can also be assigned to the user based on a variety of other conditions including awarding credits if utility meter readings are submitted by the user at a predetermined frequency, such as three times a day or more. More precisely, the server may compute a predetermined function on the set of utility meter readings of a user and the times that those readings were submitted such that, for example, credits are awarded if the maximum time interval between readings over the course of a week is less than a predetermined minimum value. If this condition is met, then the server awards credits to the user. Credits can be awarded if utility meter readings submitted by the user are verified by the server as being accurate, or if the user verifies a utility meter reading submitted by another user. For example, if the results of the optical character recognition match the numerical value of the meter reading submitted by the user, the server may award credits to the user. Also, embodiments of the invention may include awarding points when a user's submitted value is verified by another user. For example, a user may verify the submitted readings of another user by transmitting from the server to the user device a randomly selected utility meter reading submitted by another user. The user device then displays the image of the utility meter reading and the numerical value of the reading, and the user either verifies that they match or not, e.g., by selecting an ‘Correct’ button or a ‘Wrong’ button. The selection is then sent to the server from the user device. If the selection indicates that the value is verified, then the server may award credits to both the user whose value was validated as well as the user who performed the validation. Alternatively, the user device may display the image of the utility meter reading, and the user responds by typing in the numerical value of the meter reading. The typed in numerical value is then sent to the server for validation. If validated, the server may then award credits to both the user whose value was validated as well as the user who performed the validation.

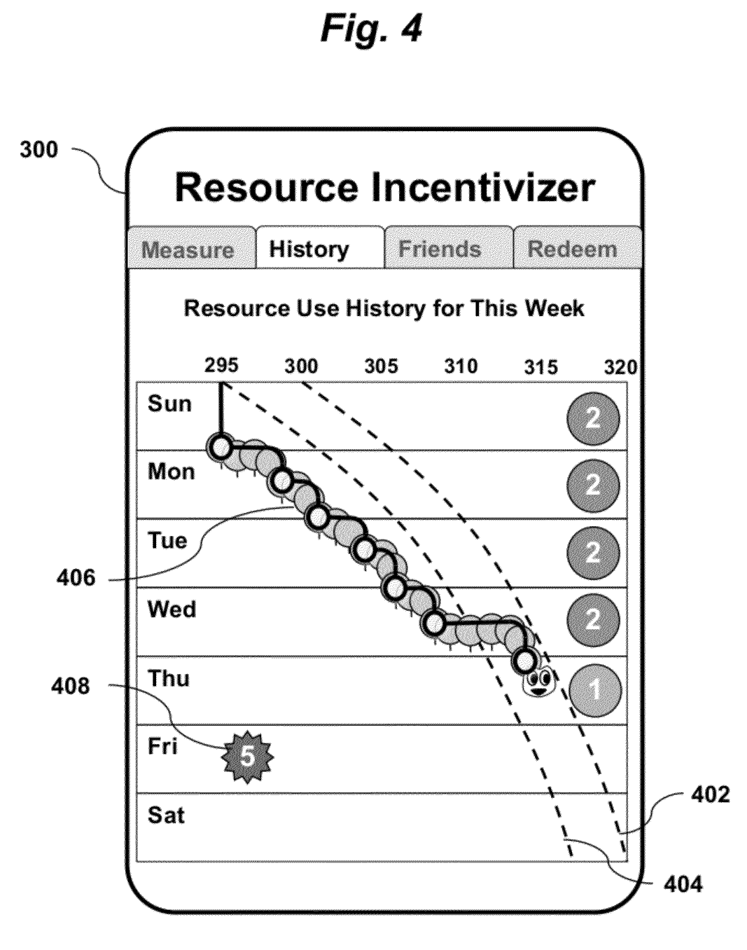

In some embodiments, the method may include calculating by the server a target resource use profile for the user based on past resource use by the user and weather forecasts. The target profile is preferably calculated in a customized manner based on the individual user-specific data such as, for example, historical resource use data, building data, localized weather forecast data, and geographical location data. The target profile may also be calculated based in part on utility resource demand predictions and credit pool budget levels for the rewards scheme. These factors are all combined in order to optimize resource use efficiency and the effectiveness of the rewards. This computed target resource use profile data, as well as other data such as localized weather data and historical resource use data, may then be transmitted to the user device for display. For example, FIG. 4 is a diagram of a smart phone user interface used for displaying historical user resource use data, target profile, and associated reward credits, according to an embodiment of the invention. The target resource use profile is indicated in the figure by the dashed lines 402 and 404. The user's historical resource use data is plotted 406 on the graph and updated as new meter readings are submitted by the user.

Historical user data may be displayed, for example, as a graph of past meter reading values with respect to time, superimposed on a target resource use profile which may include resource use zone associated with increased award credits. In a preferred embodiment, the plot 406 is represented as the progress of an animal (e.g., a caterpillar or other insect) or vehicle (e.g., car or plane). In the example shown, the user is awarded 2 points each day that the plot 406 of the meter readings remains to the left of both dashed lines. If the plot 406 is to the left of just one of the two lines, only 1 point is awarded. And if the plot 406 extends off to the right of both dashed lines, 0 points are awarded. Thus, the user is awarded a credit award if the recorded current utility meter reading indicates that the user resource consumption is less than (i.e., to the left of) the target resource use profile. It should be noted that the graph is represented so that the progress of the plot goes to the right of the most recent prior point and then downward to the next point. This naturally encourages the user to submit readings more frequently in order to keep the plot to the left of the target profile lines 404 and 402.

In some embodiments, the server may calculate a utility use recommendation for the user based on projected utility demands, such as recommendation 408 displayed as an offer of 5 credits if the user remains below the target profile on Friday of the displayed week, which is a day that the utility expects unusually high demand (e.g., due to very hot or very cold weather). The server then awards the user the credit award if the recorded current utility meter reading indicates that the user followed the utility use recommendation.

Utility use recommendations calculated by the server for the user may be calculated and offered to all customers in a particular class (e.g., in a certain geographical region) based on expectations of utility demand, availability of the utility resource, and current balance of the server's award fund. In addition, such recommendations may be calculated based on information specific to individual customers, e.g., based on past use patterns by the user, past behavior by the user in response to recommendations, and other information about the user or user's home. Such customized recommendations can offer different point award values to different users in order to optimize the value of the awards for the utility. When an individual user's meter readings indicate that they have followed the recommendation, the server awards the user a credit award.

In some embodiments, the user may set a utility use goal for a specified period of time (e.g., the coming week) and submit the goal to the server. Such goals may be submitted in response to a solicitation by the server which may include a suggestion of a goal for the user. If the recorded current utility meter readings for the specified period indicates that the user met the utility use goal, the server awards the user a credit award.

Users may also be awarded by the server a credit award if the user submits to the server a photo of a utility bill of the user. The user may, for example, take a photograph of a monthly utility bill and upload it to the server using the smartphone in a manner analogous to how the user uploads meter reading photographs. The bill photograph is preferably tagged with timestamp and location metadata. After receiving such a bill photograph from a user, the server can use it to verify meter readings for the billing period of the bill. The uploading of a utility bill by a user may also be used to facilitate initial account registration of a new user in the incentive award system. A new user, for example, can use the mobile application to enter their name 310 and utility meter serial number 306. The user can then take a photo of a recent utility bill, which the server can use to confirm that the user setting up the account is properly associated with a given utility meter.

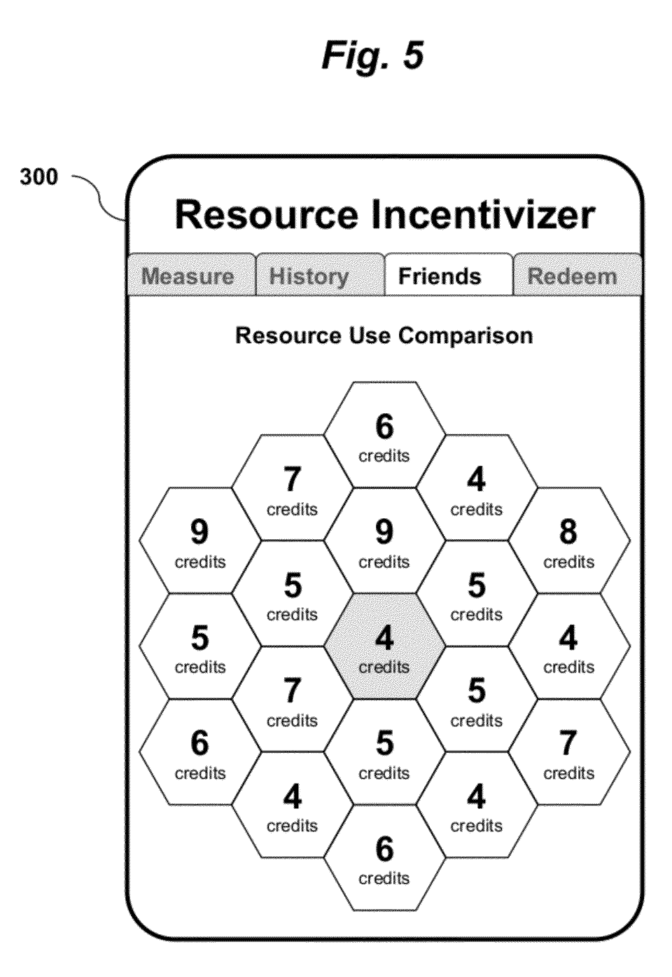

The server preferably sends to the user device various types of information at various times for display on the user device. The information may include, for example, cumulative awarded credits earned by the user, target profile data, utility use recommendations, historical user meter reading data, and so on. An embodiment illustrated in FIG. 5, for example, shows a smart phone user interface used for displaying credits awarded to other users in the user's community for comparison with credits awarded to the device user, where each hexagonal cell in the figure represents a different user in the same neighborhood. In addition to the credits awarded to each user, the information may also include the resource use of each user, resource use goals, and other information. Preferably, the information is anonymous. To implement this feature, the server maintains a social network or is integrated with a social networking system to which it transmits credit award information and other information associated with each user device. A set of neighboring users is identified by the server or social network and the credit award information for those users may be shared among those neighbors. The set of neighboring users (or “friends”) may be selected by the server based on geography or usage patterns or demographics or other characteristics of the users. Alternatively, the set may be chosen from the user's social-network friends. In some embodiments, some of the hexagonal cells may display information such as averages of resource use or credit awards across groups of users (e.g., a cell for a geographical neighbourhood, a cell for office coworkers, a cell for city residents). Some hexagonal cells may contain data for fictitious users made up by the server.

Color coding and other techniques can be used to facilitate the identification of users in the display who have earned more or fewer credits than other users in a neighborhood, or have used more or less resource. For example, other users in a neighborhood that use more resources than the device user could be displayed in red while other users in the neighborhood that use less resources than the device user could be displayed in green. The device user thus easily sees how his or her resource use compares with others in the neighborhood. A similar technique could be used for displaying award points of users in the neighborhood. In some embodiments, each cell may also display an image of a representative animal or vehicle selected by the user associated with the cell.

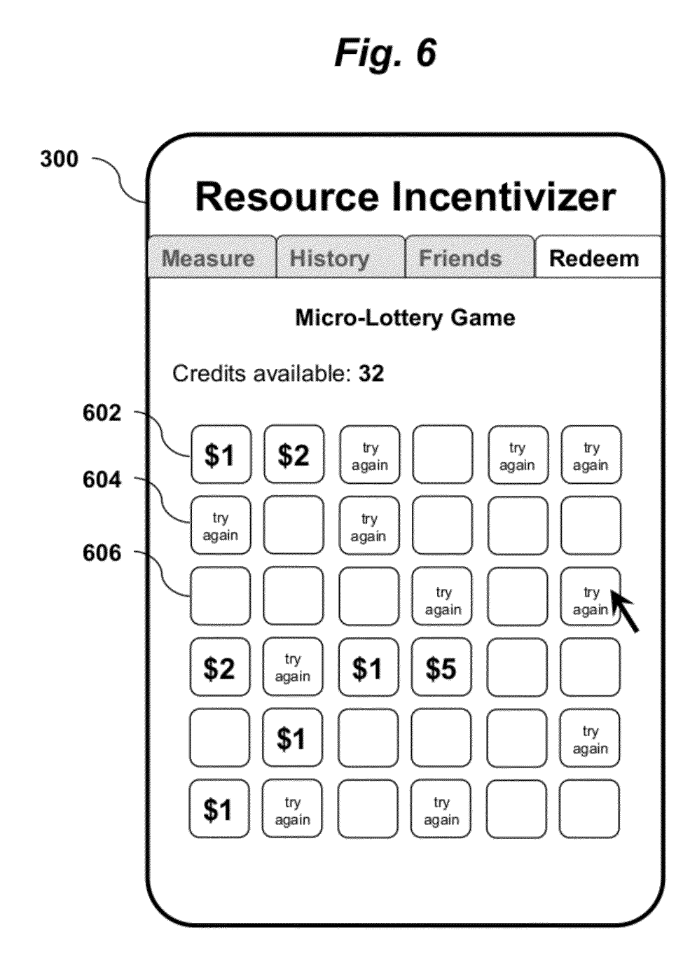

A significant feature of the incentive award system of the present invention is the integration with a micro-lottery, a micro-raffle, or other game of chance as a means for users to redeem their accumulated credit awards. For example, the server may provide and transmit information to the user device for displaying a random rewards interface on the user device. The random rewards interface may implement a lottery, micro-raffle, or other game of chance. For example, FIG. 6 is a diagram of a smart phone user interface used for displaying a random reward interface by which the user may redeem credits in exchange for participation in a game of chance. The interface includes a grid of tiles such as tiles 602, 604. The user may select one of the tiles (e.g., by clicking or tapping). When a user selects a tile, the server redeems a predetermined number of the user's accumulated credits. Upon clicking, the tile reveals either a reward prize (in which case the user has been randomly selected as a winner of the prize) or not. For example, tile 602 shows a $1 reward prize, while tile 604 shows no reward prize. Tile 606 remains unclicked. This type of game may be implemented as a single player or multiplayer game.

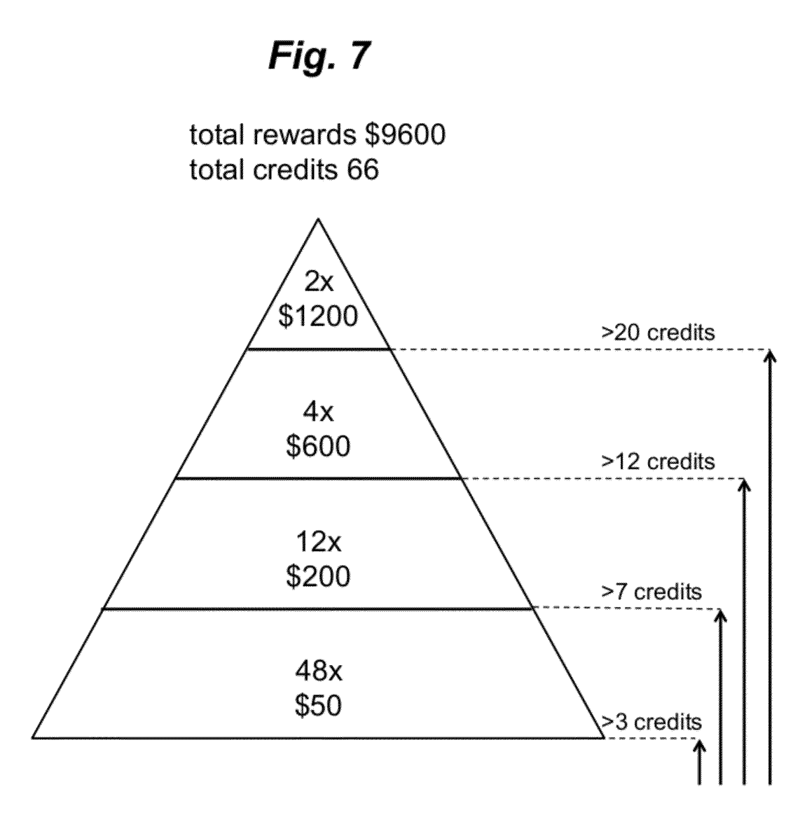

In another implementation, the raffle or lottery is held periodically (e.g., once a week), where the total value of the winner awards is determined by the total accumulated points being redeemed in that period. In some embodiments, multiple winners are selected randomly from among users awarded credits for following resource use recommendations. In some embodiments, the raffle or lottery has a pyramid style structure, a shown in FIG. 7, such that a user who has accumulated more credits has a greater chance of being selected a winner than a user who has accumulated fewer credits. Moreover, a user awarded more credits may be given a greater chance of being selected for a larger reward than a user awarded fewer credits. The pyramid structure shown in FIG. 7, for example, shows multiple levels where higher levels have larger minimum credit eligibility requirements, fewer winners, and larger rewards than lower levels. Specifically, a user with 20 credits or more is eligible to be one of the 2 winners of the top level prize of $1200, a user with 12 credits or more is eligible to be one of the 4 winners of the second level prize of $600, a user with 7 credits is eligible to be one of the 12 winners of the third level prize of $200, and a user with 3 credits or more is eligible to be one of the 48 winners of the fourth level prize of $50. This type of scheme can be implemented in various ways, including the use of games such as that shown in FIG. 6, where different grids are generated and displayed to users having different accumulated credit levels. The credits redeemed for clicking a tile, the total number of rewards in the grid, and sizes of the rewards in the grid would differ for each such grid to reflect the particular level.

The multiple levels of this scheme provide occasional winnings of smaller amounts even to users with low accumulated credits, motivating them to continue earning credits. At the same time, the scheme provides motivation for users at various credit levels to earn more credits in order to be eligible for the larger prizes at higher levels.

1. A method for incentivizing efficient use of a utility resource, the method comprising:
recording by a user device a current utility meter reading;
sending from the user device to a server the recorded current utility meter reading;
awarding by the server to the user a credit award if the recorded current utility meter reading indicates that the user engaged in desired energy use behavior;
redeeming by the server the credit award for user participation in a micro-raffle.

2. The method of claim 1 wherein the user device is a smart meter.

3. The method of claim 1 wherein the user device is a portable smartphone.

4. The method of claim 1 further comprising processing by the server an image of the current utility meter reading to recognize a digital value representing a meter reading.

5. The method of claim 4 further comprising comparing the recognized digital value with a digital value submitted by the user.

6. The method of claim 1 further comprising:
displaying by the user device a utility meter avatar while the user is taking a meter reading.

7. The method of claim 1 further comprising:
registering by the server a new user account for the user if the user submits to the server a photo of a utility bill.

8. The method of claim 1 wherein the recorded current utility meter reading comprises a utility meter serial number and a numerical value representing utility use.

9. The method of claim 1 wherein the recorded current utility meter reading comprises an image of a utility meter.

10. The method of claim 9 further comprising:
validating by the server the image by comparing time and location metadata of the image with time and location information stored at the server.

11. The method of claim 1 further comprising:
awarding by the server to the user a credit award if utility meter readings are submitted by the user at a frequency above a predetermined frequency.

12. The method of claim 1 further comprising:
awarding by the server to the user a credit award if utility meter readings submitted by the user are verified as being accurate.

13. The method of claim 1 further comprising:
awarding by the server to the user a credit award if the user verifies a utility meter reading submitted by another user.

14. The method of claim 1 further comprising:
transmitting by the server to the user device a randomly selected utility meter reading submitted by another user, where the utility meter reading comprises an image of a utility meter and a numerical value;
displaying by the user device the image of the utility meter and the numerical value;
receiving by the server from the user device a verification of the numerical value;
awarding by the server to the user a credit award.

15. The method of claim 1 further comprising:
awarding by the server to the user a credit award if the user submits to the server a photo of a utility bill of the user.

16. The method of claim 1 further comprising:
calculating by the server a target resource use profile for the user based on past resource use by the user and weather forecasts;
awarding by the server to the user a credit award if the recorded current utility meter reading indicates that the user resource consumption is less than the target resource use profile.

17. The method of claim 1 further comprising:
calculating by the server a utility use recommendation for the user based on past use by the user;
awarding by the server to the user a credit award if the recorded current utility meter reading indicates that the user followed the utility use recommendation.

18. The method of claim 1 further comprising:
calculating by the server a utility use recommendation for the user based on projected utility demands;
awarding by the server to the user a credit award if the recorded current utility meter reading indicates that the user followed the utility use recommendation.

19. The method of claim 1 further comprising:
receiving by the server from the user a utility use goal for a specified time period;
awarding by the server to the user a credit award if the recorded current utility meter reading indicates that the user met the utility use goal.

20. The method of claim 1 further comprising sending to the user information including cumulative awarded credits earned and historical user data.

21. The method of claim 1 further comprising displaying by the user device historical user data as a graph of past meter reading values with respect to time, superimposed on a target resource use profile.

22. The method of claim 21 wherein the graph represents the historical user data as the progress of an animal.

23. The method of claim 21 wherein the target resource use profile includes a resource use zone associated with increased award credits.

24. The method of claim 1 further comprising:
calculating by the server a predetermined function computed on a set of utility meter readings of the user and times that those meter readings were submitted by the user;
awarding by the server to the user a credit award if the maximum time interval between the set of utility meter readings over a predetermined time period is less than a predetermined minimum value.

25. The method of claim 1 further comprising:
transmitting by the server to a social network credit award information associated with the user device, whereby the credit award information may be shared in the social network with neighbors of the user.

26. The method of claim 1 further comprising:
providing by the server a random rewards interface to the user device.

27. The method of claim 1 further comprising:
randomly selecting by the server a winner from among users awarded credits;
transferring rewards to the randomly selected winner.

28. The method of claim 27 wherein the randomly selecting by the server is selects multiple winners from among users awarded credits.

29. The method of claim 27 wherein the randomly selecting by the server a winner is performed such that a user awarded more credits has a greater chance of being selected than a user awarded fewer credits.

30. The method of claim 27 wherein the randomly selecting by the server a winner is performed such that a user awarded more credits has a greater chance of being selected for a larger reward than a user awarded fewer credits.
